(19) United States
(12) Patent Application Publication
(10) Pub. No.: US 2003/0155894 A1
(43) Pub. Date: Aug. 21, 2003

(54) DC to DC converter with tapped inductor

(75) Inventors: Ajit Dubhashi, Redondo Beach, CA (US); Bertrand Vaysse, Toulouse (FR)

Correspondence Address: OSTROLENK FABER GERB & SOFFEN, 1180 AVENUE OF THE AMERICAS, NEW YORK, NY, 100368403

(73) Assignee: International Rectifier Corporation

(21) Appl. No.: 10/360,438

(22) Filed: Feb. 6, 2003

Related U.S. Application Data
(60) Provisional application No. 60/354,729, filed on Feb. 7, 2002.

(51) Int. Cl. G05F 1/613

(52) U.S. Cl. 323/225

(57) ABSTRACT

A switching converter comprising: a first switch having a first terminal adapted to be coupled to a first DC voltage, an inductor having a first terminal coupled to a second terminal of the first switch; the inductor having a tap and a second terminal; the second terminal coupled to a capacitor, the capacitor adapted to have a second DC voltage thereon; and a second switch having a first terminal coupled to the tap of the inductor and a second terminal coupled to a common line coupling said first and second DC voltages.

### CROSS REFERENCE TO RELATED APPLICATIONS

This application claims the benefit and priority of U.S. Provisional Application No. 60/354,729, filed Feb. 7, 2002 and entitled DC TO DC CONVERTER WITH TAPPED INDUCTOR, the disclosure of which is incorporated herein by reference.

### FIELD OF THE INVENTION

This invention relates to DC to DC converters and more specifically, to buck converter circuits and in particular, to a circuit for reducing the cost of such converters.

### BACKGROUND OF THE INVENTION

Buck converter circuits are well known. FIG. 1 shows a typical buck converter circuit to convert a DC input 10 to a lower DC output 11 (of lower voltage) on an output capacitor. The circuit includes a switching transistor, e.g., a vertical conduction IGBT or MOSFET 12, a diode 13 and an inductor 14. A suitable control signal, e.g., a PWM control (not shown) is applied to the gate G of MOSFET 12 and is controlled from the output voltage at 11 to maintain a given output. No isolation is required between the grounds of the two voltages. The recirculating diode 13 sources the inductor current when transistor 12 is off. It can be replaced by another switching transistor operating as a synchronous rectifier and controlled so that it is on when switch 12 is off and vice versa. The circuit has been analyzed in particular for the automotive application of 42 to 14V (i.e. ratio of 3) conversion but is applicable, in general, to any ratios that are higher than 2.

In this particular application, if the input voltage is about three times as much as the output voltage, the consequent duty cycle of the main switch 12 is about 0.33. This means that the RMS ripple current in the filter capacitors 11 is high thus requiring bigger or more expensive capacitors.

FIG. 2 uses three (but smaller average power capacity) buck converter “cells” (with subscripts a, b and c) that are operated at 33% duty cycle with a 120 degree phase shift between them. This method produces very little capacitor ripple current (theoretically zero). However, this method requires three of everything (such as switches, drivers, inductors, diodes etc). Due to this fact, it is more difficult to mechanically layout the circuit on a board and the circuit has added expense, although the filter is less expensive.

It would be desirable to reduce the number of components needed for this application and to simplify layout implementation while still reducing capacitor ripple.

### BRIEF DESCRIPTION OF THE INVENTION

In accordance with the invention, the standard single buck converter cell is modified by tapping the inductor and connecting the recirculating diode (or a synchronous rectifier) to the tap. Two such cells can also be used to further reduce ripple current.

The invention comprises a switching converter comprising: a first switch having a first terminal adapted to be coupled to a first DC voltage, a first inductor winding having a first terminal coupled to a second terminal of the first switch; the first inductor winding having a second terminal; the second terminal of the first inductor winding coupled to a first terminal of a second inductor winding and thereby forming a common connection, the second inductor winding having a second terminal coupled to a capacitor, the capacitor adapted to have a second DC voltage thereon; and a second switch having a first terminal coupled to the common connection of the first and second inductor windings and a second terminal coupled to a common line coupling said first and second DC voltages.

According to another aspect of the invention comprises a switching converter comprising: a first switch having a first terminal adapted to be coupled to a first terminal of a first DC voltage, a first inductor winding having a first terminal coupled to a second terminal of the first switch, the first inductor winding having a second terminal, the second terminal of the first inductor winding coupled to a first terminal of a second inductor winding and thereby forming a common connection, the second inductor winding having a second terminal coupled to a capacitor, the capacitor having first and second terminals and having a second DC voltage thereaccross, and a second switch having a first terminal coupled to the common connection of the first and second inductor windings and a second terminal coupled to one of common line coupling a second terminal of said first DC voltage and a terminal of said second DC voltage, and a second terminal of said first DC voltage.

According to yet another aspect, the invention comprises a switching converter comprising: a first switch having a first terminal adapted to be coupled to a first DC voltage, a first inductor winding having a first terminal coupled to a second terminal of the first switch, the first inductor winding having a second terminal, a second inductor winding having a first terminal coupled to the first terminal of the first inductor winding and thereby forming a common connection, the second inductor winding having a second terminal coupled to a capacitor, the capacitor adapted to have a second DC voltage thereon, and a second switch having a first terminal coupled to the second terminal of the second inductor winding and a second terminal coupled to a common line coupling said first and second DC voltages.

### BRIEF DESCRIPTION OF THE DRAWINGS

FIG. 1 is a circuit diagram of a known buck converter circuit.

FIG. 2 shows a multi cell buck converter circuit of the prior art.

FIG. 3 is a circuit diagram employing the tapped inductor of the invention.

FIG. 4 shows the circuit of FIG. 3 in which the diode switch is replaced by an active switch.

FIG. 5 is a graph comparing the output voltage to duty cycle for various ratios of N2/(N1+N2);

FIG. 6 shows another embodiment.

### BRIEF DESCRIPTION OF THE INVENTION

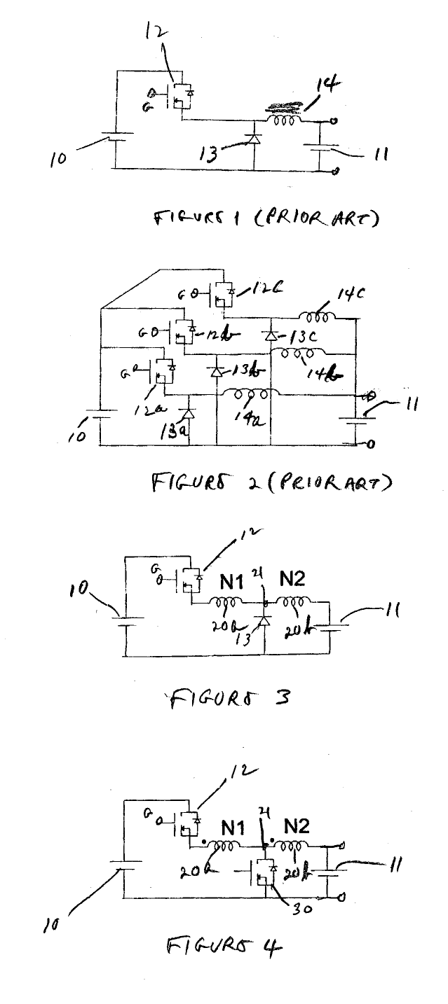

FIG. 3 is a circuit diagram of the present invention in which the inductor 14 of FIG. 1 is replaced by a center tapped inductor 20a, 20b having its node 21 connected to diode 13. Alternatively, two inductor windings on a common core can be employed. The solution of FIG. 3 modifies the standard buck converter cell and modifies the inductor 14 to add another node. The ratio of inductor turns N1 to N2 is preferably 1:1 for an application that has a one to three ratio of reduction such as in an automotive 42 to 14V conversion and can be further optimized according to the desired application. The inductor turns ratio can be chosen based on the application requirements and the governing equation is gain=D/((1/p)*(1−D)+D). In this equation D is the duty cycle of the top switch and p is the ratio of N2 to (N1+N2). This is shown in the chart of Table 1.

Two such modified cells can be used (as shown in FIG. 2 but with tapped inductors) to provide a lower ripple current implementation that has fewer components.

In the previous embodiment, p=1 condition is that of a standard buck converter and has a gain of simply D. As p is reduced (i.e. N1 is increased or more N1s are added) the gain is reduced in the range between D=0 and D=1, as shown in FIG. 5 for various values of p.

TABLE I
P = N2(N1 + N2)

| | p | | | | | |
|---|---|---|---|---|---|---|
| D | 1 | 0.75 | 0.5 | 0.33 | 0.2 | 0.1 |
| 1 | 1.00 | 1.00 | 1.00 | 1.00 | 1.00 | 1.00 |
| 0.8 | 0.80 | 0.75 | 0.67 | 0.57 | 0.44 | 0.29 |
| 0.6 | 0.60 | 0.53 | 0.43 | 0.33 | 0.23 | 0.13 |
| 0.5 | 0.50 | 0.43 | 0.33 | 0.25 | 0.17 | 0.09 |
| 0.4 | 0.40 | 0.33 | 0.25 | 0.18 | 0.12 | 0.06 |
| 0.2 | 0.20 | 0.16 | 0.11 | 0.08 | 0.05 | 0.02 |
| 0.1 | 0.10 | 0.08 | 0.05 | 0.04 | 0.02 | 0.01 |

FIG. 6 shows another embodiment in which the top switch is in the middle and the bottom switch is shifted. This topology may have the reverse effect i.e. of increasing the gain in the midrange. This could help reduce the size of the filtering capacitors even more.

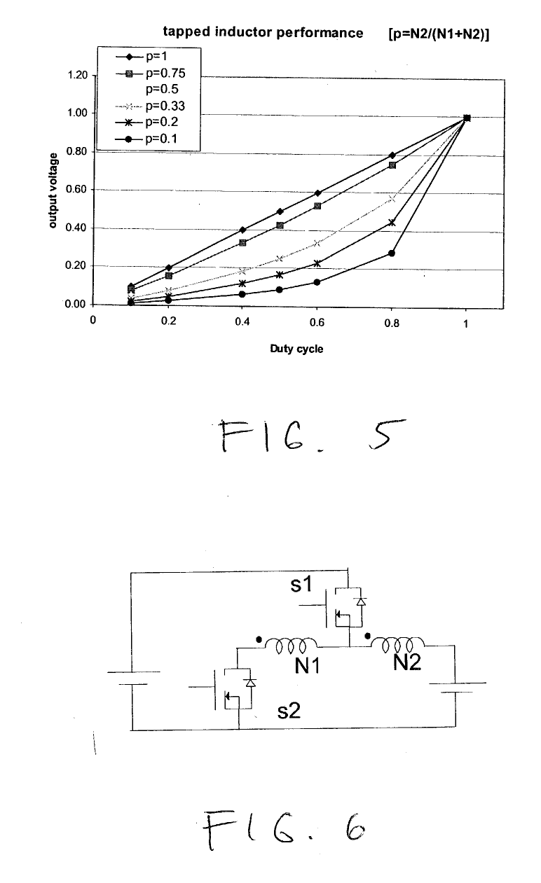

In applications that require the power flow to be reversed (i.e., bidirectional current flow in which the circuit operated as a boost converter for the reverse current flow), the circuit can be modified further by substituting the diode 13 by an active switch such as an FET or IGBT as shown in FIG. 4 by MOSFET 30. This also allows for better efficiencies (in case of low bus voltages) by using synchronous rectification in which the gate control to MOSFET 30 operates the synchronous rectifier to act like the diode 13. In order to reverse the current flow the two transistor switches are appropriately controlled by the PWM controller, not shown.

The following table (Table 2) compares the two approaches (advantages and vantages) especially for a 42 to 14V converter:

TABLE 2

| | | Three standard | |
|---|---|---|---|
| | | Buck Converters | Two tapped inductor |
| | Aspect | (FIG. 2) | Buck Converters |
| 1 | Capacitor ripple | Lowest | Very low |
| 2 | Number of components | 3X a standard | 2X a standard Buck |
| | | buck | |
| 3 | Top switch Voltage | 75 V | 75 V |
| | rating | | |
| 4 | Bottom switch voltage | 75 V | Can be lower, up to |
| | rating | | about 40 V so rdson |
| | | | can be lower |
| 5 | Controller complexity | 3 phase capable. | Can use 2 phase, off |
| | | Unique | the shelf compo- |
| | | components. | nents |
| 6 | Power reversal | Possible | Possible |
| 7 | Stability | Not a problem | More difficult |
| 8 | Layout implementation | More complex | Less complex |
| 9 | Driver complexity | Standard drivers | Drivers need - ve |
| | | are acceptable | level shift |
| 10 | Magnetics | Standard | 1/Tapped construc- |
| | | construction | tion 2/Leakage |
| | | | inductance |
| | | | has to be minimized |
| | | | (absorbed by switch |
| | | | avalanche) |

Although the present invention has been described in relation to particular embodiments thereof, many other variations and modifications and other uses will become apparent to those skilled in the art. Therefore, the present invention should not be limited by the specific disclosure herein.

What is claimed is:

1. A switching converter comprising:
a first switch having a first terminal adapted to be coupled to a first terminal of a first DC voltage;
a first inductor winding having a first terminal coupled to a second terminal of the first switch; the first inductor winding having a second terminal; the second terminal of the first inductor winding coupled to a first terminal of a second inductor winding and thereby forming a common connection, the second inductor winding having a second terminal coupled to a capacitor, the capacitor having first and second terminals and having a second DC voltage thereacross; and
a second switch having a first terminal coupled to the common connection of the first and second inductor windings and a second terminal coupled to one of:
a common line coupling a second terminal of said first DC voltage and a terminal of said second DC voltage; and
a second terminal of said first DC voltage.

2. The switching converter of claim 1, wherein the first and second inductor windings comprise a single inductor and the common connection comprises a tap.

3. The switching converter of claim 1, wherein the second switch is a diode.

4. The switching converter of claim 3, wherein the diode is polarized such that its cathode is coupled to the common connection.

5. The switching converter of claim 2, wherein the second switch is a diode and wherein the diode is polarized such that its cathode is coupled to the inductor tap.

6. The switching converter of claim 1, wherein the first and second switches are transistors.

7. The switching converter of claim 1, wherein the first switch is controlled by a control signal to control the level of the second DC voltage.

8. The switching converter of claim 7, wherein the control signal is a PWM control signal.

9. The switching converter of claim 6, wherein the first and second switches are controlled by control signals to control the, level of the second DC voltage.

10. The switching converter of claim 1, wherein the second switch is a synchronous rectifier.

11. The switching converter of claim 2, wherein the inductor tap is a center tap and a turns ratio of the two inductor windings on either side of the tap is 1:1.

12. The switching converter of claim 2, wherein the inductor tap location is optimized to lower a voltage rating of the second switch.

13. The switching converter of claim 1, wherein two switching converters are provided having a common input and common output, with each first switch of each switching converter having a 50% duty cycle and a 180° phase shift.

14. The switching converter of claim 2, wherein two switching converters are provided having a common input and a common output, with each first switch of each switching converter having a 50% duty cycle and a 180° phase shift.

15. The switching converter of claim 1, wherein the common line coupling the first and second DC voltages comprises a ground return line.

16. The switching converter of claim 6, wherein the switching converter is bidirectional so that the first and second switches are controlled by a controller to allow current to flow from either the first DC voltage to the second DC voltage or from the second DC voltage to the first DC voltage.

17. The switching converter of claim 6, wherein the first and second switches are controlled so that the level of the first DC voltage is controlled.

18. The switching converter of claim 1, wherein the first and second inductor windings have a common core.

19. A switching converter comprising:
a first switch having a first terminal adapted to be coupled to a first DC voltage;
a first inductor winding having a first terminal coupled to a second terminal of the first switch; the first inductor winding having a second terminal; the second terminal of the first inductor winding coupled to a first terminal of a second inductor winding and thereby forming a common connection, the second inductor winding having a second terminal coupled to a capacitor, the capacitor adapted to have a second DC voltage thereon; and
a second switch having a first terminal coupled to the common connection of the first and second inductor windings and a second terminal coupled to a common line coupling said first and second DC voltages.

20. A switching converter comprising:
a first switch having a first terminal adapted to be coupled to a first DC voltage;
a first inductor winding having a first terminal coupled to a second terminal of the first switch; the first inductor winding having a second terminal; a second inductor winding having a first terminal coupled to the first terminal of the first inductor winding and thereby forming a common connection, the second inductor winding having a second terminal coupled to a capacitor, the capacitor adapted to have a second DC voltage thereon; and
a second switch having a first terminal coupled to the second terminal of the second inductor winding and a second terminal coupled to a common line coupling said first and second DC voltages.
